(19) United States
(12) Patent Application Publication
(10) Pub. No.: US 2025/0173519 A1
(43) Pub. Date: May 29, 2025

(54) Query Intent Understanding and Search Result Generation

(71) Applicant: Google LLC, Mountain View, CA (US)

(72) Inventors: Kai-Yang Chiang, Sunnyvale, CA (US); Huiliang Ling, Sunnyvale, CA (US); Gokhan Mergen, Los Gatos, CA (US); Gaurav Gupta, Dublin, CA (US)

(21) Appl. No.: 18/523,177

(22) Filed: Nov. 29, 2023

(51) Int. Cl. G06F 40/40; G06F 16/332; G06F 16/383

(52) U.S. Cl. CPC G06F 40/40; G06F 16/3329; G06F 16/383

(57) ABSTRACT

Systems and methods for performing a search based on chat data can include determining search results for user queries by generating multi-turn aware queries with a generative language model to include additional details associated with a determined intent of the queries. The generative language model may receive a user query and multi-turn chat data indicative of a chat session of the user and determine an intent of the user query based on the user query and the multi-turn chat data. The generative language model may generate a multi-turn aware query by rewriting the user query to include details associated with the determined intent of the user query, and the multi-turn aware query may be utilized for search result determination. A generative language model may be leveraged to tune an embedding model that may be used for query intent determination.

### FIELD

The present disclosure relates generally to query intent determination. More particularly, the present disclosure relates to leveraging a generative model to determine an intent of a query based on a chat session history, which can then be leveraged to generate a contextually aware query.

### BACKGROUND

With the growth of artificial intelligence (AI) chatbots, chat-style interfaces and chat-style communication can be a common tool utilized for AI chatbot interactions and, in some instances, internet searches. As a user engages with a system via a chat-style interface and generates a history of inputs and responses, each message may become dependent on the previous inputs and/or responses, and as a result may be less understandable in isolation. However, the chat may culminate in an actionable question and/or command. A question and/or command that may not be understandable when processed separate from the other messages.

A traditional search query may be crafted to include descriptive information to generate an accurate response. With a chat interface, the user may begin omitting information in their queries that was provided in previous response, which may include the use of pronouns and/or discussing specifics without indicating the general topic. Without the context of the history of inputs and responses, the system may have difficulty accurately determining the intent of a user's given query. When a search engine cannot accurately determine the intent of a user's query, the search engine may identify and/or provide search results that may not be responsive to the intent of the user. The system may be unable to generate content items and responses that reflect what the user is requesting.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for generating a contextually aware query. The method can include obtaining, by a computing system including one or more computing devices, an input query. The method can include obtaining, by the computing system, multi-turn query data, the multi-turn query data may be descriptive of previous inputs obtained before the input query. The previous inputs and the input query can be associated with a particular multi-turn session. The method can include processing, by the computing system, the input query and the multi-turn query data to generate the contextually aware query. The contextually aware query can be descriptive of the input query and additional details. The additional details can be descriptive of a context of the input query associated with the multi-turn query data. The method can include processing, by the computing system, the contextually aware query with a machine-learned embedding model to generate a query embedding. The method can include determining, by the computing system, a query embedding cluster associated with the query embedding. The query embedding cluster can be associated with a plurality of other embeddings associated with a plurality of other queries. The method can include determining, by the computing system, a plurality of search results based on the query cluster.

In some implementations, the method can include determining, by the computing system and based on the query embedding cluster, one or more attributes associated with the query embedding. The one or more attributes can be descriptive of a particular topic associated with at least one of the input query or the multi-turn query data.

In some implementations, determining the query embedding cluster associated with the query embedding can include mapping, by the computing system, the query-intent pair to an embedding space. Determining the query embedding cluster associated with the query embedding can include determining, by the computing system and based on at least one of the query embedding or an intent embedding, the query-intent pair is associated with a plurality of other embeddings associated with a node within a query graph.

In some implementations, the method can include determining, by the computing system, a plurality of media content items based on the query embedding cluster.

Another example aspect of the present disclosure is directed to a computing system for generating a multi-turn aware query. The system can include one or more processors and one or more non-transitory computer-readable media that collectively store instructions that, when executed by the one or more processors, cause the computing system to perform operations. The operations can include obtaining an input query. The operations can include obtaining multi-turn query data. The multi-turn query data can be descriptive of previous inputs obtained before the input query. The previous inputs and the input query can be associated with a particular multi-turn session. The operations can include processing the input query and the multi-turn query data with a machine-learned language model to generate the multi-turn aware query. The multi-turn aware query can be descriptive of the input query augmented with additional details determined based on the multi-turn query data. The operations can include processing the multi-turn aware query with a machine-learned embedding model to generate a query embedding. The operations can include determining a query embedding cluster associated with the query embedding. The operations can include determining a plurality of search results based on the query cluster.

Another example aspect of the present disclosure is directed to one or more non-transitory computer-readable media that collectively store instructions that, when executed by a computing system, cause the computing system to perform operations. The operations can include obtaining input data, the input data including a query. The operations can include processing the query with an embedding model to generate a query embedding. The operations can include processing the input data with a generative model to determine a query intent, the query intent may be descriptive of a type of information being requested. The operations can include obtaining, based on the query intent, one or more second query embeddings associated with one or more second queries with one or more second query intents. The one or more second query intents may be associated with the query intent of the input data. The operations can include evaluating a loss function that evaluates a difference between the query embedding and the one or more second query embeddings. The operations can include adjusting one or more parameters of the embedding model based at least in part on the loss function.

In some implementations, the query may include a rewritten query generated by obtaining an input query and multi-turn query data. The multi-turn query data may be descriptive of previous inputs obtained before the input query. The previous inputs and the input query may be associated with a particular multi-turn session. The rewritten query may be generated by processing the input query and the multi-turn query data with a language model to generate the rewritten query.

In some implementations, the operations may include determining an intent embedding is associated with the query intent, and the one or more second query embeddings can be obtained based on the intent embedding.

In some implementations, the operations can include generating a remodeled data graph of query clusters based on the query embedding, the intent embedding, and the one or more query embeddings.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an overview block diagram of an example query intent determination system according to example embodiments of the present disclosure.

FIG. 2 depicts a detailed block diagram of an example query intent determination system according to example embodiments of the present disclosure.

FIG. 3 depicts a flow chart diagram of an example method to perform contextually aware query generation and search result determination according to example embodiments of the present disclosure.

FIG. 4 depicts a block diagram of an example query rewriting system generating a contextually aware query according to example aspects of the present disclosure

FIG. 5 depicts a block diagram of an example component of a search result determination system according to example embodiments of the present disclosure.

FIG. 6 depicts a block diagram of an example embedding model training system according to example embodiments of the present disclosure.

FIG. 7 depicts a block diagram of an example intent attribute determination system according to example embodiments of the present disclosure.

FIG. 8 depicts a flow chart diagram of an example method to determine search results according to example embodiments of the present disclosure.

FIG. 9 depicts a flow chart diagram of an example method to perform according to example embodiments of the present disclosure.

FIG. 10A depicts a block diagram of an example computing system that performs search result generation according to example embodiments of the present disclosure.

FIG. 10B depicts a block diagram of an example computing system that performs search result generation according to example embodiments of the present disclosure.

Reference numerals that are repeated across plural figures are intended to identify the same features in various implementations.

### DETAILED DESCRIPTION

Generally, the present disclosure is directed to systems and methods for generating search results for queries based on a contextually aware query generated with a generative model and based on a multi-turn chat session. In particular, the systems and methods disclosed herein can leverage a generative language model (e.g., a Large Language Model (LLM)), to process an input query and data associated with the input query to generate a contextually aware query that includes detailed information associated with the query and the query context. For instance, a generative language model may process previous messages and responses thereto in a user chat session, along with a query, and determine an intent of the query. The generative language model may generate a multi-turn aware query that includes the determined intent of the query. For example, a user may interact with a chat bot via a chat-style interface and may exchange a plurality of messages. As the user continues to interact with the system, their messages may depend on topics (and/or details) within previous messages and/or responses, which can cause the intent of the messages to be indeterminate when viewing the messages in isolation.

To determine the intent of the messages, the system may be able to process the user's current message and a chat session history with a generative language model. The generative language model may determine the semantics of the message and the chat session history and generate a multi-turn aware message (e.g., contextually aware query). The multi-turn aware message may be descriptive of the intent of the initial message and the chat session history. The generative model may leverage the language understanding, semantic analysis, and generative capabilities of the generative language model to generate the multi-turn aware message. Using the multi-turn aware message, the system may generate responses and/or media content items based on the multi-turn aware message and may provide the determined and/or generated content items as responses to the user's input message.

To generate responses and/or media content items for a multi-turn aware query, a system may utilize a data graph (e.g., a query embedding cluster graph, query graph, intent graph, and/or query intent graph). The data graph (and/or intent graph) may include a graph representation that leverages learned query clusters and learned intent-cluster associations. The query embedding cluster graph may contain clusters of similar queries linked together based on common attributes, such as intents. The systems and methods may process the multi-turn aware query with an embedding model to determine a query embedding within the intent graph for the multi-turn aware query. The systems and methods can then process the query embedding to determine an intent of the query based at least in part on determining an association with one or more query embedding clusters. Based on the associated embedding clusters, the systems and methods may determine, generate, and/or obtain search results and/or media content items.

Some aspects of the present disclosure may be directed to training and/or tuning machine-learned models based on intent determinations from provided queries. In particular, intents of provided queries may be determined via a generative language model (e.g., LLMs, vision language models (VLMs), etc.), and the determined intents may be utilized to evaluate a loss function for training query embedding models and/or adjusting an intent graph (and/or a task graph that maps query clusters to particular tasks). A query embedding model may process a query as input and generate a query embedding that maps the query to an embedding space associated with an intent graph that includes a plurality of learned distributions and/or query clusters associated with an intent graph. For example, a query embedding model may process a query and map the query to an intent embedding space associated with queries associated with similar query intents.

In some implementations, the embedding model may be tuned using a generative language model and a loss function. The loss function may process a query embedding and an intent determination from a generative model. The loss function may determine a loss between the query embedding and the intent determination which may be used to improve the query embedding model. For instance, the gradient descent of the loss between the query embedding and the intent determination may be backpropagated to the query embedding model to adjust one or more parameters of the query embedding model. The embedding model can be trained and/or tuned to generate query embeddings that are associated with (e.g., proximate to and/or similar to) embeddings of the intents associated with the query and other query embeddings with similar intents. By leveraging the intent determination of the generative model, the embedding model can be trained to generate similar embeddings for a query and a respective intent for the query, which can incentivize intent-based distributions.

Chat-style interfaces can provide a more immersive experience for user interactions for obtaining information via a web platform. However, chat-style interfaces can struggle with large-scale intent understanding when processing queries and/or prompts. Chat-style interfaces can encourage users to engage with their system in a more conversational method than traditional search systems. A chat-style interface can cause a user to provide a plurality of messages (and/or queries) in which each query may be related to one another based on a similar topic and/or based on building off a previous message and/or topic. As the user continues to engage in the query session, a plurality of messages (e.g., user messages and chat bot responses) can be generated and/or received that may begin referencing previous messages, whereas, in a traditional search system, each query a user provides may be treated as an independent session without association to prior sessions. When a user relies on and/or references topics or details from the history of queries and responses, the exact intent of their future queries may be difficult to discern when looking at the text of the future query in isolation. For example, a user may reference an object in a proper noun form at one point in a query session but may later reference the object using a pronoun because they have already mentioned the object in proper noun form within the session (e.g., “Tell me about the new smartphone from Brand X,” then “how much does it cost?”). A search system may have difficulty determining the intent of the later query using the pronoun without knowledge of the earlier query using the proper noun. In a traditional one-time search system, a user may only ever use the proper noun form of an object as there is no history of queries for the user to reference.

The utilization of generative language models to rewrite queries can eliminate the difficulties of determining intents for queries from chat-style interfaces. A generative language model may be leveraged to interpret, understand, and textualize a given chat session. The generative language model can be trained on a plurality of natural language processing tasks and may be trained to perform semantic understanding and conditional text string generation. In some implementations, the generative language model can include an autoregressive language model trained to learn sequence representations to predict a next word in a sequence based on previous words and/or previous data in an input dataset. As a result, the generative language model may be able to understand a wide breadth of linguistic situations and requests. For instance, a generative model may be able to determine links between separate excerpts of text such as, for example, an intent of one text based on the content and context of another text. More specifically, a generative language model may be able to determine an intent of a given query based on a history of queries and responses thereto. For example, a generative model may be provided with a query from a chat-style interface which includes a history of queries and responses thereto. The generative model may process the data and rewrite the query such that the rewritten query embodies the intent of the query based on the history of queries and responses thereto. The generative model may determine a common topic between the query and the history of queries and responses and include details associated with the common topic in the query to generate the rewritten query.

Generative language models may improve search result relevancy and determination by processing existing queries within intent graphs and determining relevant queries and associations within the intent graphs. An intent graph may include a plurality of clusters in which each cluster can include a plurality of associated query embeddings and may be associated with a plurality of nodes linking together similar clusters. A generative language model may determine nuances and intents of the queries embeddings within clusters and discover similar clusters to the query embeddings. Based on the discovered similar clusters, new edges may be generated between the clusters of the query embeddings and the discovered similar clusters.

Training query embedding models using intent determinations from generative language models may improve model performance and output accuracy, reducing computational cost for processing received queries, by reducing iterative search instances. For instance, a query embedding model may be trained using a loss function that generates a loss between a generated query embedding for a given input from the query embedding model and an intent determination for the given input from a generative language model. The loss may be provided to the query embedding model to train or tune one or more parameters of the query embedding model. A query embedding model with improved accuracy may reduce the iterations of result determination and generation to satisfy a received query. For example, a less accurate embedding model may result in a user having to provide multiple queries regarding the same question to achieve the desired answer, whereas an embedding model tuned based on generative language model intent determinations may achieve the desired answer on the first try, which can reduce search instances.

The systems and methods of the present disclosure provide a number of technical effects and benefits. As one example, the system and methods may be utilized to determine search results that are responsive to an intent of a multi-turn chat session. Additionally and/or alternatively, the systems and methods may leverage a generative language model to train and/or tune a query embedding model to generate query embeddings that cluster embeddings based on intents. The multi-turn aware queries and the learned intent distributions of the query embedding clusters can be utilized to determine, generate, and/or obtain search results and/or media content items that are responsive to an intent of a chat session without manual query recrafting and/or without iterative searches and refinement. A computing system may require less computational resources to fulfill their requests when they are provided more accurate responses to given queries and may forgo additional search queries that normally may be necessary to satisfy their requests. Additionally, or alternatively, with more accurate query embedding models, a system may have improved computational efficiency in satisfying a user request. For instance, more accurate query embeddings may reduce the iterations within the system to satisfy a user request (e.g., a system iterates query embeddings until an acceptable solution is generated).

The systems and methods of the present disclosure provide a number of technical effects and benefits. In particular, implementations of the present disclosure can reduce server-side resource utilization when executing user searches by generating and utilizing contextually aware queries to retrieve search results for user queries. Determining responses using contextually aware queries may provide responses with greater accuracy and mitigate further iterations of queries and responses to satisfy a user search.

For example, conventional search techniques can exhibit sub-optimal performance when searching queries related to nuanced topics, niche interests, technically sophisticated subject matter, etc. In turn, the sub-optimal performance can necessitate the user to perform multiple search iterations to refine a query based on initial results, thus causing substantial network bandwidth utilization and compute resource utilization for the server performing the search. However, by leveraging contextual information and generative language models, implementations of the present disclosure can substantially reduce, eliminate, and/or mitigate, the need to perform multiple search iterations to refine a query, thus obviating the bandwidth utilization and compute resource utilization associated with such iterations.

With reference now to the Figures, example embodiments of the present disclosure will be discussed in further detail.

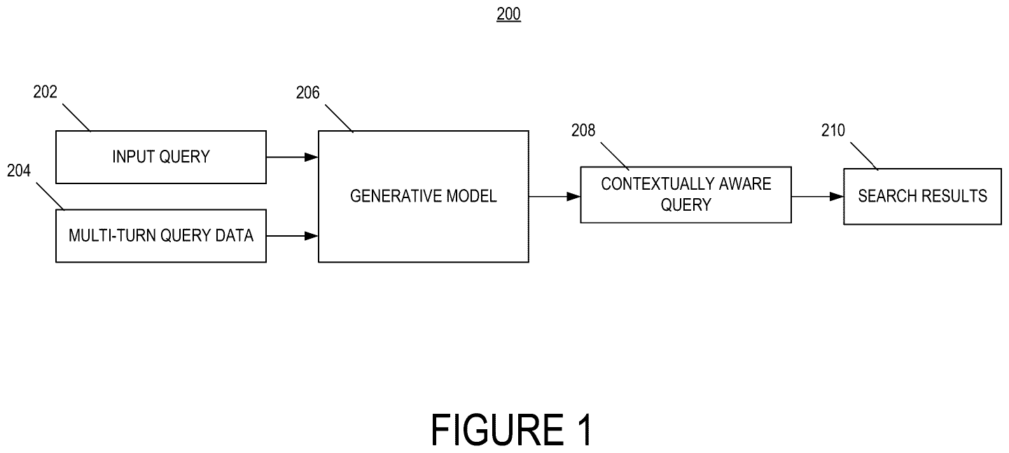

FIG. 1 depicts an overview block diagram of an example query intent determination system 200 according to example implementations of the present disclosure. In some implementations, the system 200 receives an input query 202 and multi-turn query data 204 as input. In some instances, the input query 202 may be indicative of a user's search query. The multi-turn query data 204 may include a plurality of messages (e.g., user search queries and/or prompts to a chat bot (e.g., a large language model enabled chat bot)) and responses thereto. In some instances, the plurality of messages and responses thereto may have been made by a user and be associated with the input query 202. For example, the input query 202 may be a new user query preceded by the plurality of user messages and chat bot responses within the multi-turn query data 204. The input query 202 and multi-turn query data 204 may be processed with a generative language model 206 (e.g., large language model) to determine an intent of the input query 202 based on the multi-turn query data 204. For example, the input query 202 may include a generic query using a pronoun that is indecipherable without additional context (e.g., without the chat session history). The multi-turn query data 204 may include a user message (e.g., a previous user search query and/or a user prompt) and/or response (e.g., a chat bot response) that includes a noun which corresponds to the pronoun used in the input query 202. The generative language model 206 may generate a contextually aware query 208 (e.g., a multi-turn aware query) indicative of the intent of the input query 202 relative to the multi-turn query data 204 as an output. The contextually aware query 208 can be generated to include the semantics of the input query 202 while adding additional details determined based on the chat session history of the multi-turn query data 204. For example, the input query 202 may include a statement such as, for example, “how much does it cost?” and the multi-turn query data 204 may show a common subject of “a new smartphone.” Thus, the generative language model 206 may generate a contextually aware query 208 that includes “how much does the new smartphone cost?” deciphering the intent of the input query 202. The contextually aware query 208 may then, in place of and/or in addition to the input query 202, be used to determine search results 210. In some implementations, the search results 210 may include media content items and/or relevant web search results.

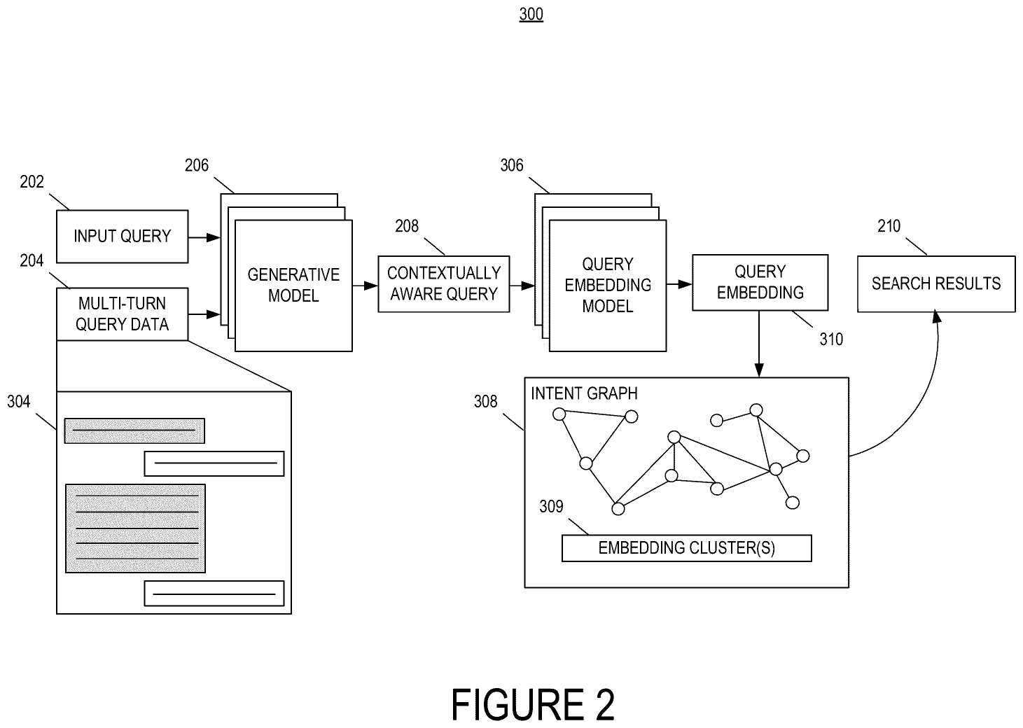

FIG. 2 depicts a detailed block diagram of an example query intent determination system 300 according to example implementations of the present disclosure. The system 300 receives the input query 202 and multi-turn query data 204 as input and generates search results 210. In some implementations, the multi-turn query data 204 may include a plurality of queries and responses 304. For instance, the input query 202 may be a query from a chat-style search interface and the multi-turn query data 204 may include a plurality of user messages (e.g., a plurality of user search queries and/or a plurality of user prompts input into a chat bot interface) and responses 304 (e.g., chat bot responses generated with a language model) made in the chat-style interface before the input query 202. In some implementations, the input query 202 may include multi-modal data including two or more different types of data. For example, the input query 202 may include image data, text data, audio data, video data, latent encoding data, statistical data, and/or multimodal data. In some implementations, the multi-turn query data 204 including the plurality of queries and responses 304 may include image data and text data that may be associated with each other. The generative model may be configured and/or trained to process multimodal data (e.g., a vision language model).

The input query 202 and multi-turn query data 204 may be processed with a generative language model (e.g., large language model) 206 to generate the contextually aware query 208. The generative language model 206 may be a generative language model trained on a large breadth and depth of tasks and/or topics (e.g., the generative model may be trained on a plurality of natural language processing tasks). For example, the generative language model may be trained on a plurality of tasks, not any one specific operation or task (e.g., generating a natural language response). The generative language model 206 may be trained to generate API calls that may be processed in series and/or in parallel with the contextually aware query 208. The contextually aware query 208 may be a rewritten version of the input query 202 to include additional details associated with the context of the multi-turn query data 204 and plurality of messages and responses 304. For example, the input query 202 may include language dependent on previous user messages and/or chat bot responses within the multi-turn query data 204. For instance, a pronoun within the input query 202 that was intended to refer to a noun within the multi-turn query data 204. The generative language model 206 may rewrite the input query 202 to incorporate the intended reference within the multi-turn query data 204, and the contextually aware query 208 may include all necessary information to accurately determine the intent of the original input query 202.

The contextually aware query 208 may be processed with a query embedding model 306 (e.g., machine-learned embedding model) to generate a query embedding 310. The query embedding 310 can be descriptive of a plurality of values associated with a plurality of features of the contextually aware query 208. The query embedding 310 may map a query to an embedding space associated with a data graph. For instance, the query embedding model 306 may generate a query embedding 310 that maps the contextually aware query 208 to a query cluster in an embedding space. The query cluster may be associated with a learned distribution within the intent graph 308. In some implementations, the query embedding model 306 may be trained to generate query embeddings 310 that clusters queries with similar query intents. For example, the query embedding model 306 may be trained to generate query embeddings with similar values for queries identified as having the same intent (e.g., “How much is the new Brand Y Controller?” and “Cost of Brand Y Controller” may be processed to generate similar query embeddings based on a shared query intent). The query embedding model 306 may generate a plurality of query embeddings, which may be clustered into a plurality of query embedding clusters 309. The plurality of query embedding clusters 309 can be processed to determine a plurality of learned distributions, which may be learned and utilized to generate the intent graph 308.

The query embedding 310 may be descriptive of a plurality of features associated with the contextually aware query 208. The query embedding 310 may be associated with one or more query embedding clusters 309 that may be associated with one or more intents of the intent graph 308. The intent graph 308 can include a plurality of nodes and edges and may include a graphical representation that identifies similar queries with similar intents. The intent graph 308 may include a graph data structure including a plurality of edges and nodes. In some implementations, the nodes of the intent graph 308 may include one or more embedding cluster(s) 309 indicative of a group of similar query embeddings. For example, the query embedding 310 may map the contextually aware query 208 to a particular embedding cluster of the embedding cluster(s) 309 which includes similar queries with similar intents. The edges between the embedding cluster(s) 309 may link clusters 309 with closely related intents and/or other attributes (e.g., topics, subjects, etc.) based on the queries within the clusters 309. In some implementations, the edges can be utilized for determining follow-up query suggestions as nodes associated with a similar topic may be linked via the edges. For example, an embedding cluster associated with costs for a particular product may be associated with a node linked via an edge of the intent graph 308 to a node associated with locations to purchase the particular product.

The query embedding clusters 309 may be utilized to determine and/or generate search results 210. For instance, the embedding cluster associated with the query embedding 310 may include already understood queries and their intents. The understood queries may be used to generate search results for the contextually aware query 208, and the input query 202, based on their determined similarity. The search results 210 may include media content items related to the embedding cluster associated with the query embedding 310. In one implementation, the search results 210 may include multi-modal data including two or more types of data. For instance, the search results 210 may include text data and image data related to the embedding cluster the contextually aware query 208 is mapped to.

In some implementations, the query embedding clusters 309 can be leveraged to determine search results 210 responsive to the input query 202 by processing the contextually aware query 208 and/or one or more other queries in the embedding cluster 309 with a search engine to determine a plurality of search results. Alternatively and/or additionally, one or more content items may be tagged and/or indexed in association with a particular intent and/or a particular embedding cluster. The tagged and/or indexed content item may be provided as a search result for queries determined to be associated with the particular query embedding cluster. For example, a reliable encyclopedia entry content item may be tagged such that a query associated with a particular topic (e.g., Vancouver Island Marmot) may be processed and responded to with the reliable encyclopedia entry content item. One or more content items may be tagged to different nodes of the intent graph 308 (and/or task graph) to provide uniform surfacing of the content item when query embeddings associated with a particular embedding cluster are received.

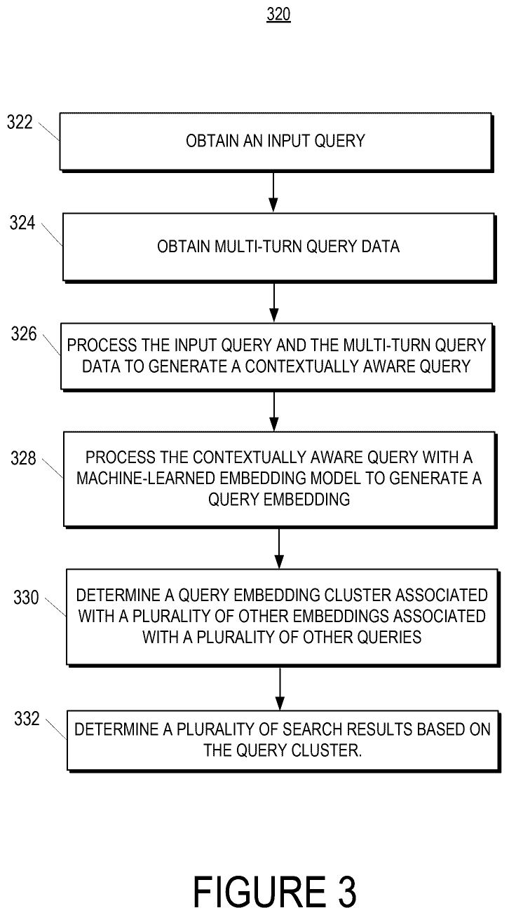

FIG. 3 depicts a flow chart diagram of an example method 320 to perform contextually aware query generation and search result determination according to example implementations of the present disclosure. Although FIG. 3 depicts steps performed in a particular order for purposes of illustration and discussion, the methods of the present disclosure are not limited to the particularly illustrated order or arrangement. The various steps of the method 320 can be omitted, rearranged, combined, and/or adapted in various ways without deviating from the scope of the present disclosure.

At 322, a computing system can obtain an input query. The input query can include a message within a chat interface. The input query may be preceded by a plurality of other messages in a chat session. The plurality of other messages can include user messages (e.g., user search queries and/or user prompts) and/or chat bot messages (e.g., generative language model generated responses). In some implementations, the input query may include multimodal data including two or more different types of data. For example, the input query may include text data and image data (e.g., a query that includes “what are the calories of this one compared to the other one?” and an image of a box of cereal).

At 324, the computing system can obtain multi-turn query data. In some implementations, the multi-turn query data may be descriptive of previous inputs obtained before the input query, and the previous inputs may be associated with the same multi-turn session (e.g., a chat session history associated with a particular chat session instance) as the input query. For example, a user may be engaged in a chat-style search session and the input query may be the user's latest query. The multi-turn query data may include the plurality of messages (e.g., the plurality of queries and responses) exchanged (e.g., provided, received, and/or generated) in the search session prior to the user's latest query. The multi-turn query data can be descriptive of a chat session history that includes a plurality of user messages and a plurality of chat bot responses (e.g., responses generated with a language model that processes the user messages).

At 326, the computing system can process the input query and the multi-turn query data to generate a contextually aware query. The contextually aware query may include the semantics of the input query with additional details indicative of a context of the input query relative to the multi-turn query data (e.g., the generative model may replace a dependent pronoun within the input query with the respective noun determined based on processing a chat session history of the multi-turn query data). In some implementations, where the input query may be multi-modal data, the contextually aware query may be determined based on the image data and text data associated with the chat session for the input query.

At 328, the computing system can process the contextually aware query with a machine-learned embedding model to generate a query embedding. The query embedding can be associated with a plurality of values determined based on processing the contextually aware query. The query embedding can be generated based on features of the contextually aware query associated with one or more topics and/or semantics of the query. The machine-learned embedding model may be trained on query-intent pairs (e.g., (query, intent)). The query intent may be associated with an intent of the corresponding query. The machine-learned embedding model can process the query and the intent of the query-intent pair to generate a query embedding and an intent embedding. A loss function can be evaluated by comparing the intent embedding and the query embedding. One or more parameters of the machine-learned embedding model can then be adjusted based on the gradient descent generated by the loss function based on the comparison of the query embedding and the intent embedding. The adjustment can be based on incentivizing the machine-learned embedding model to generate similar embeddings for the query and the corresponding intent. In some implementations, the machine-learned embedding model may be trained to generate similar embeddings for queries with similar query intents. For example, the model may be trained to map the queries “build your own smartphone case,” “DIY phone case,” and “make it yourself phone case” all to the same embedding cluster due to their similar topic of self-created phone cases.

At 330, the computing system can determine a query embedding cluster associated with the query embedding. In some implementations, the query embedding cluster may be associated with a plurality of other embeddings associated with a plurality of other queries. For example, the query embedding may include the query “best budget smartphone case” and the determined query embedding cluster may be “affordable smartphone cases” and include the query “cheap smartphone case.” Determining a query embedding cluster associated with the query embedding may include determining the query embedding is associated with a plurality of other query embeddings within a learned distribution. The query embedding cluster determination may include determining the contextually aware query is associated with a plurality of other queries associated with a node within an intent graph. In some implementations, the query embedding cluster may be associated with a learned intent graph. For instance, the query embedding cluster may be a node within a learned intent graph including nodes of similar queries with edges connecting clusters with similar intents or attributes (e.g., topics, subjects, etc.).

At 332, the computing system can determine a plurality of search results based on the query cluster. For instance, the query cluster may include already known queries with already determined search results. Therefore, the system may generate the plurality of search results for the query cluster based on the queries within the query cluster and the already determined search results for said queries. In some implementations, determining the plurality of search results can include processing the contextually aware query and/or one or more other queries associated with the query embedding cluster with one or more search engines. Additionally and/or alternatively, determining the plurality of search results can include determining one or more content items are associated with the query embedding cluster and/or the intent graph node. The one or more content items can be tagged and/or indexed content items that are indexed with a particular cluster and/or particular node. Alternatively and/or additionally, search results may be determined based on caching search results associated with other queries in the query embedding clusters. In some implementations, an intent embedding and/or latent encoding data associated with the node in the intent graph may be processed with a search engine to determine the plurality of search results.

Additionally, and/or alternatively, the method 320 may include determining one or more attributes associated with the query embedding. Specifically, a system may determine attributes that may be descriptive of a particular topic associated with either the input query or the multi-turn query data. In some implementations, the one or more attributes may be determined based on the query embedding cluster. For example, a system may determine an intent of the input query and one or more attributes of the intent (e.g., it is a “commercial facing” (e.g., the user is interested in buying something) intent or it is a “late-stage purchase process” intent (e.g., the user is far along in the purchasing process)). In another example, the one or more attributes may be about the queries themselves (e.g., the query is a “niche” query or the topic of the query is an “economical” topic). In practice, there may be a variety of different attributes a system may determine and utilize in determining search results.

Additionally, and/or alternatively, the method 320 may include determining a plurality of media content items based on the query embedding cluster. For instance, the system may determine the query embedding cluster relates to something well-suited for display via a media such as, for example, a picture or video. In some implementations, the media content item(s) (e.g., picture or video) may be determined along with search results or in lieu of.

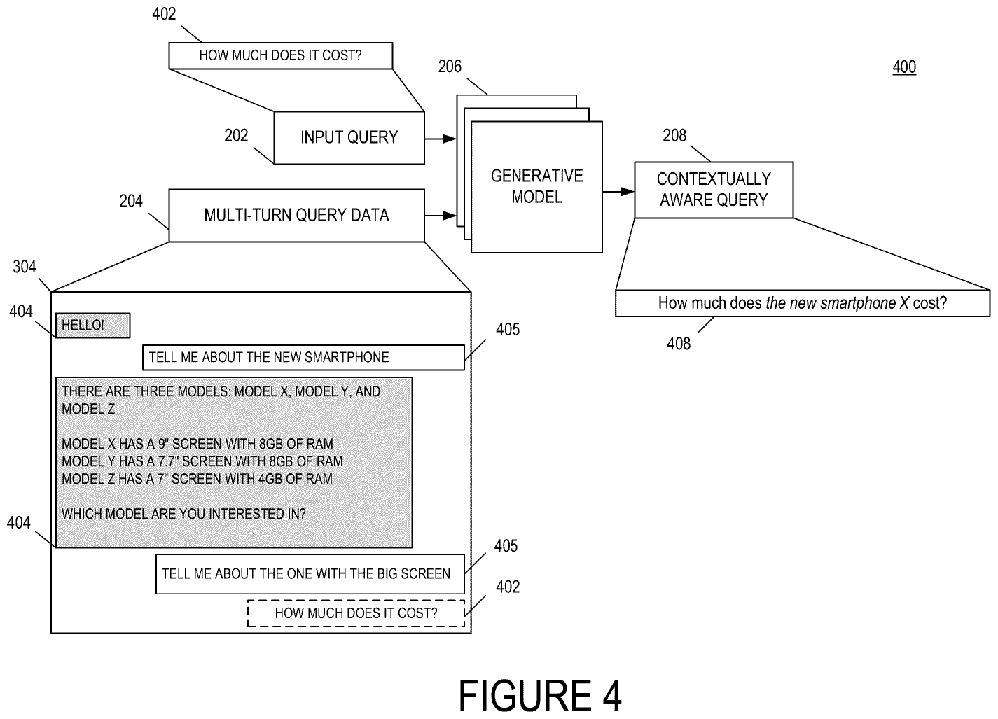

FIG. 4 depicts a block diagram of an example query rewriting system 400 generating a contextually aware query according to example aspects of the present disclosure. Similar to the systems depicted in FIGS. 1-2, the system may include a generative language model 206 that receives, as input, an input query 202 and multi-turn query data 204 and may generate a contextually aware query 208.

In one example, the input query may be the example query 402. The example query 402 may be a simple question: “How much does it cost?” without anything more. The example query 402 may be an accurate question, yet the “it” is unknown. Therefore, determining the subject of the input query 202 may be difficult without additional information.

Additional information may be provided by the multi-turn query data 204 via the plurality of queries and responses 304. In one example, the plurality of messages (e.g., queries) and responses 304 may include example user messages 405 (e.g., queries and/or prompts) and example responses 404 (e.g., chat bot responses). For example, the example user messages 405 may request information for a “new smartphone” over a series of messages. The example responses 404 may provide information regarding the “new smartphone” based on the example user messages 405. In some instances, the example query 402 may be a part of, and come from, the same query session as the multi-turn query data 204.

The generative language model 206 may generate the contextually aware query 208 based on the input query 202 and additional information provided by the multi-turn query data 204. For example, the generative language model 206 may generate the example contextually aware query 408 based on the example input query 402 and the example user messages 405 and the example responses 404 of the multi-turn query data 204. The generative language model may rewrite the example input query 402 to include the additional information from the multi-turn query data 204 by replacing the unknown “it” within the example input query 402 with the “new smartphone” topic discussed in the example user messages 405 and example responses 404. In some implementations, and as depicted, the generative language model 206 may utilize information from both the user messages and the responses of the plurality of user queries and responses 304 to determine the contextually aware query 208.

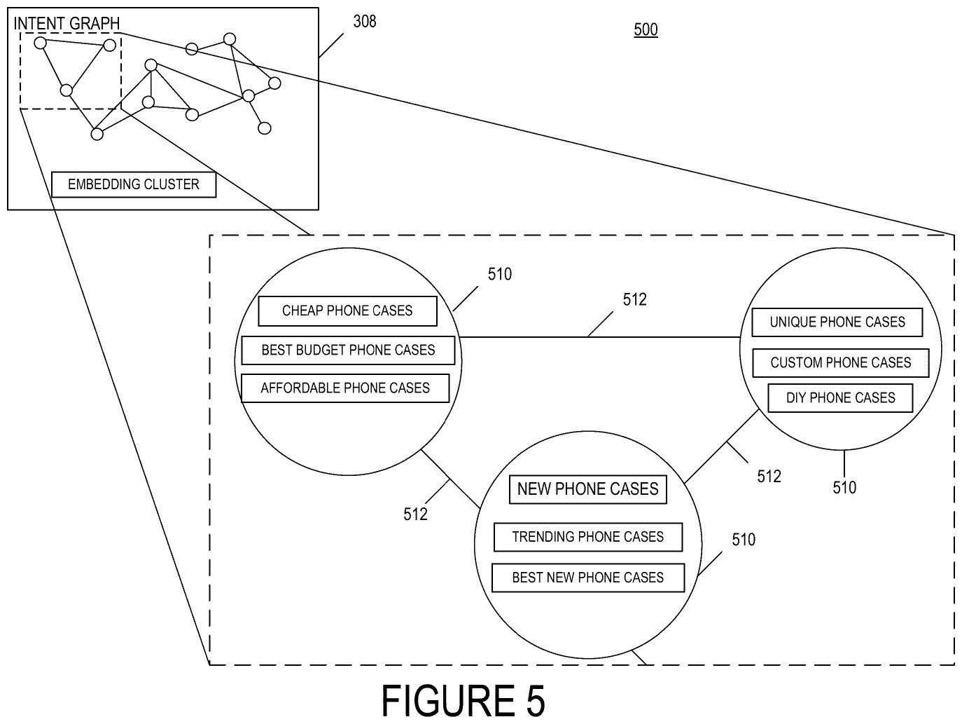

FIG. 5 depicts a block diagram of an example component of a search result determination system 500 according to example implementations of the present disclosure. The search result determination system 500 may include a graph data structure, such as the intent graph 308. In some implementations, the intent graph 308 may include a plurality of learned nodes such as the plurality of query clusters 510. For instance, the intent graph 308 may include a plurality of query clusters 510 where each cluster includes one or more queries that include related query intents. In one example, a query cluster may include queries such as “cheap phone cases,” “best budget phone cases,” and “affordable phone cases.” In this example, the queries can be clustered based on the related query intents of low-price and economical phone cases. As another example, a query cluster of the plurality of query clusters 510 may include the queries “new phone cases,” “trending phone cases,” and “best new phone cases.” In this example, the queries are clustered based on the related query intents of the latest and new phone cases.

In some implementations, the intent graph 308 may include a plurality of edges 512 interconnecting the plurality of nodes, such as the plurality of query clusters 510. For instance, the plurality of edges 512 may connect nodes with related node intents such as, for example, query clusters with related query intents. For example, an edge of the plurality of edges 512 may connect a query cluster associated with low-price and economical phone cases with a query cluster associated with the latest and new phone cases. The edge may signify the related query intents between the two query clusters (e.g., their basis around smartphone cases, or their likely potential to purchase intent).

It should be appreciated that the example query clusters and edges depicted and discussed herein may be for exemplary purposes only. In practice, the intent graph 308 may include infinitely many query clusters and edges linking said clusters based on a variety of topics and queries.

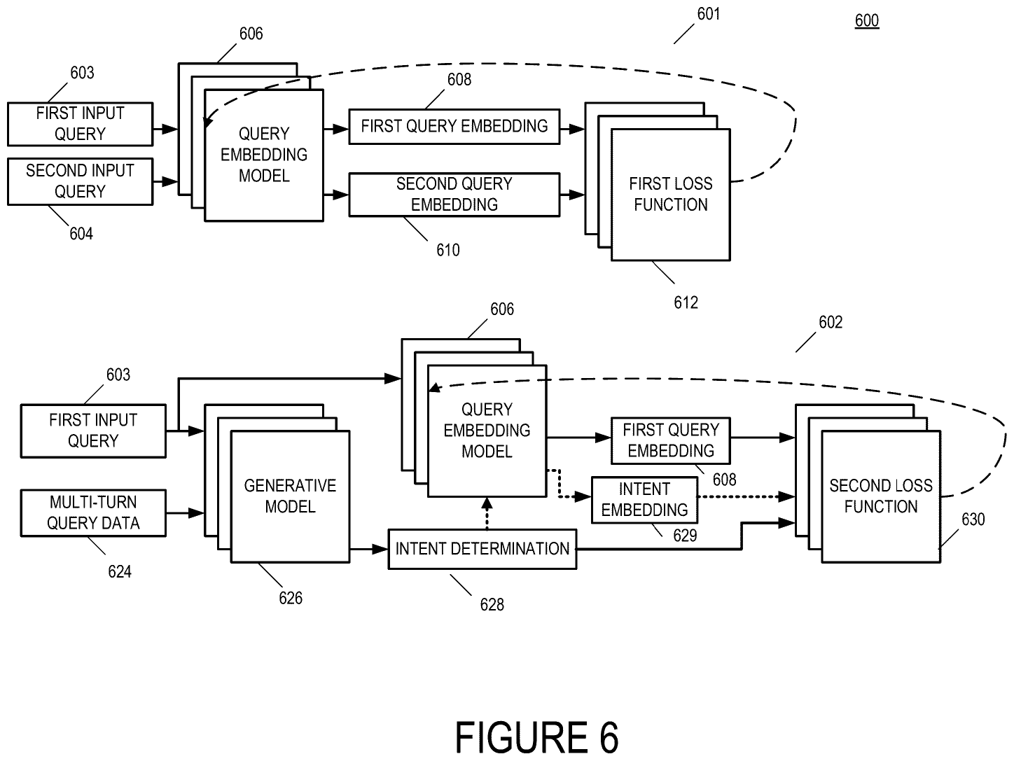

FIG. 6 depicts a block diagram of an example embedding model training system 600 according to example implementations of the present disclosure. The example embedding model training system 600 may include a first training pipeline 601 and a second training pipeline 602. The first training pipeline 601 and second training pipeline 602 may be used to train a query embedding model 606 by backpropagating an output of a first loss function 612 and/or a second loss function 630 to the query embedding model 606, respectively. In some implementations, the first training pipeline 601 may be used to train the query embedding model 606, and the second training pipeline 602 may be used for fine tuning the query embedding model 606. In one implementation, the second training pipeline 602 may be used for training the query embedding model 606, and the first training pipeline 601 may be for fine tuning the query embedding model 606. Alternatively and/or additionally, the first training pipeline 601 and/or the second training pipeline 602 may be performed in parallel and/or in series for training and/or fine tuning.

The first training pipeline 601 may train and/or tune the query embedding model 606 by comparing an output (e.g., query embeddings) of multiple input queries via the first loss function 612. For instance, the query embedding model 606 may receive a first input query 603 and a second input query 604 as input. The query embedding model 606 may generate a first query embedding 608 based on the first input query 603 and a second query embedding 610 based on the second input query 604. The first query embedding 608 and second query embedding 610 may be utilized to evaluate a first loss function 612 to determine a loss between the two embeddings. The gradient descent determined based on the first loss function 612 may be backpropagated to the query embedding model 606 to adjust one or more parameters of the query embedding model 606 to train (and/or adjust) the output generation. For example, two queries with similar intents may be input as the first input query 603 and second input query 604. Their query embeddings, the first query embedding 608 and second query embedding 610 respectively, may be input to the first loss function 612 to generate a loss. The loss may be back propagated to the query embedding model 606 to train the embedding generation to output similar embeddings for queries with similar intents.

The second training pipeline 602 may train or tune the query embedding model 606 by comparing output of the first input query 603 and multi-turn query data 624 via the second loss function 630. The multi-turn query data 624 may include a plurality of queries and responses associated with the first input query 603 from a same query session. For example, a user may be engaging in a chat-style query session and their latest query is the first input query 603 and the multi-turn query data 624 is the rest of the queries and responses from the query session. In one implementation, the first input query 603 may be provided to the query embedding model 606 to generate a first query embedding 608, and input to a generative language model 626 along with multi-turn query data 624 to generate an intent determination 628. The intent determination may be a textual representation (and/or a latent encoding) and/or a label (e.g., a classification label) of the generative language model's 626 determined intent of the first input query 603 based on the first input query 603 and multi-turn query data 624. The first query embedding 608 and the intent determination 628 may be processed with the second loss function 630 to generate a loss which may be backpropagated to the query embedding model 606 to train and/or tune the model. In some implementations, the intent determination 628 may be processed with the query embedding model 606, and/or other query embedding models trained in parallel with the query embedding model 606 to generate an intent embedding 629. The intent embedding 629 may be utilized to evaluate the second loss function 630 in lieu of and/or in combination with the intent determination 628, along with the first query embedding 608 to generate a loss. The loss may then be backpropagated to the query embedding model 606 to train and/or fine tune the model.

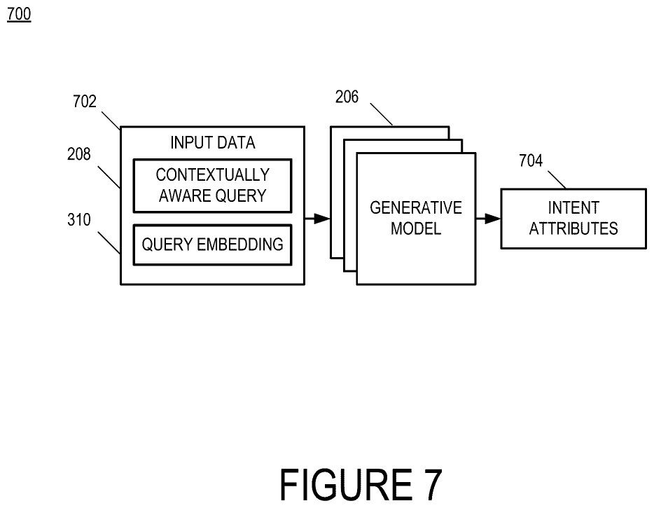

FIG. 7 depicts a block diagram of an example intent attribute determination system 700 according to example implementations of the present disclosure. The example intent attribute determination system 700 may receive input data 702 including at least one of the contextually aware query 208 or the query embedding 310. For example, the system 700 may receive the query embedding 310 as input data 702. The input data 702 may be input to the generative language model 206 to generate one or more intent attributes 704. The intent attributes 704 may be indicative of one or more attributes associated with the determined intent of the input data 702. For example, the contextually aware query 208 may be included in the input data 702 and the generated intent attributes 704 may be that the intent of the input data 702 (e.g., contextually aware query 208) is a “consumer facing” intent, it is a “late-stage funnel” intent (e.g., the user is very far along in potentially purchasing an item), or it is a “niche question.” In one implementation, the intent attributes 704 may be used to determine search results for a query associated with the input data 702 or stored for use with queries later associated with the input data 702.

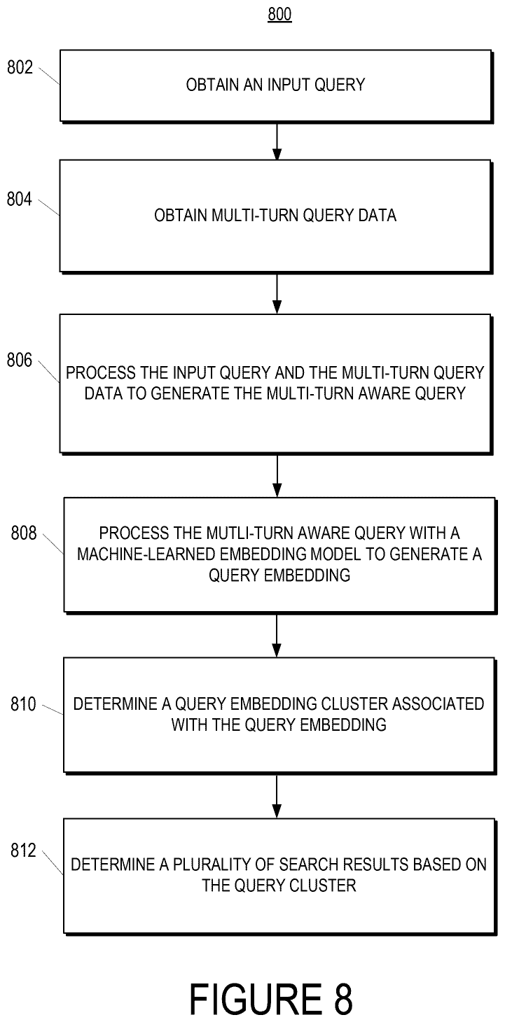

FIG. 8 depicts a flow chart diagram of an example method 800 to determine search results according to example implementations of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain an input query. For instance, the computing system may receive an input query from a user via a chat-style query session. The user may provide a plurality of messages (e.g., a plurality of queries and/or a plurality of prompts) within the chat session (and/or query session) and the input query being one of the plurality of messages. In some implementations, the input query may include multi-modal data including two or more different types of data. For example, the input query may include text data as well as image data. In another implementation, the input query may include audio data, text data, and image data.

At 804, the computing system can obtain multi-turn query data. The multi-turn query data may be descriptive of previous inputs obtained before the input query. In some instances, the previous inputs and the input query are associated with a particular multi-turn session (e.g., chat-style query session). For example, the computing system may obtain an entire chat-style query session, including queries and responses, as the multi-turn query data. Specifically, the computing system may obtain a query from the chat-style query session as the input query and the rest of the data associated with the chat-style query session as the multi-turn query data.

At 806, the computing system can process the input query and the multi-turn query data with a machine-learned language model to generate the multi-turn aware query. The multi-turn aware query may be descriptive of the input query augmented with additional details determined based on the multi-turn query data. For example, the input query may include a question that utilizes pronouns such as, for example, “how much does it cost?” The multi-turn query data may include a history of queries and responses regarding the common topic, “the new smartphone X.” The generative language model may process the input query and the multi-turn query data (e.g., data descriptive of a chat session history) to generate a multi-turn aware query that states “how much does the new smartphone X cost?”, which can include adding the proper noun from the multi-turn query data in place of the pronoun from the input query. In some implementations, the machine-learned language model may include a generative language model pre-trained on a diverse variety of content and text to perform a plurality of different language processing tasks. For example, the generative language model may be trained to process natural language inputs to perform text predictions, text corrections, text augmentation, classifications, sentiment analysis, semantic understanding, data augmentation, and/or other tasks. As a result, the machine-learned language model may be able to perform a variety of tasks besides generating multi-turn aware queries. In some implementations, the generative model may be a pre-trained machine-learned language model.

At 808, the computing system can process the multi-turn aware query with a machine-learned embedding model to generate a query embedding. In some implementations, the query embedding model may be trained and/or tuned using queries and a generative model. For example, the query embedding model may be trained by generating a first query embedding for a first input query and a second query embedding for an intent determination provided by the generative model. The generative model may generate the intent determination based on the first input query and a query session history. The first query embedding and the second query embedding may be processed by a loss function to generate a loss that may be backpropagated through to the query embedding model to train the model. In one implementation, the intent determination may be input to the loss function along with the first query embedding to generate a loss that may be backpropagated through to the query embedding model to train the model.

At 810, the computing system can determine a query embedding cluster associated with the query embedding. The query embedding cluster may be a cluster of embeddings associated with a plurality of different queries with a similar query intent to the multi-turn aware query. The query embedding cluster may be associated with a node within a task graph, the task graph being a data graph including a plurality of nodes associated with a plurality of different query tasks. In some implementations, the query embedding cluster may include a plurality of different queries associated with one or more shared attributes, and the one or more shared attributes may be associated with one or more query intents. For example, a query embedding cluster may include a plurality of different queries that share attributes (e.g., having the same topic, “smartphone cases,” having a similar intent, “buying a smartphone case”, and/or having the same type of intent, “a consumer-facing intent” and/or “a late stage buying intent”).

At 812, the computing system can determine a plurality of search results based on the query cluster. For instance, the computing system may determine an accurate answer to the input query provided, given it is an informational question, or links to the requested resource or item. In general, the computing system may determine an accurate response for the input query based on the query embedding cluster associated with the query embedding. In some implementations, the plurality of search results may include multi-modal data, such that the plurality of search results include at least two or more types of data. For example, the plurality of search results may include text data and image data. In another example, the plurality of search results may include text data, image data, and audio data.

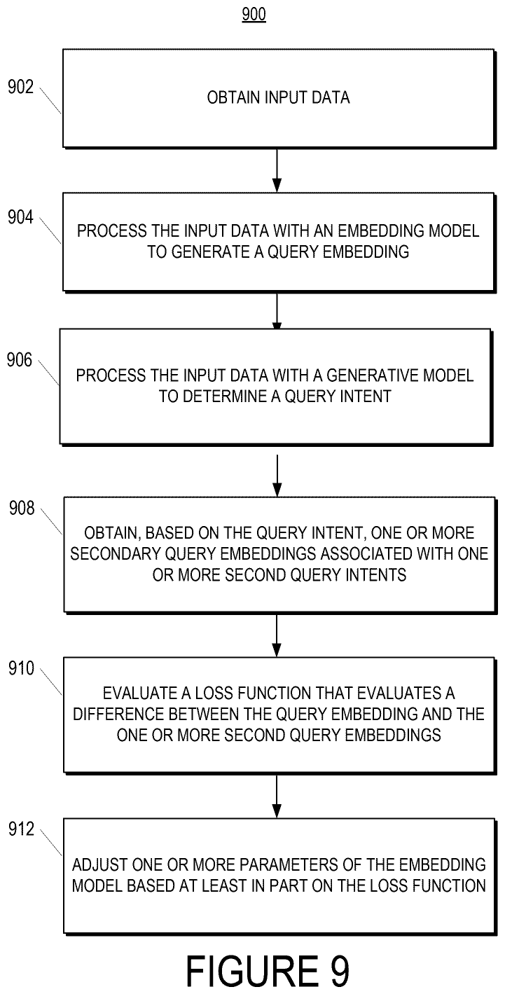

FIG. 9 depicts a flow chart diagram of an example method 900 to perform according to example implementations of the present disclosure. Although FIG. 9 depicts steps performed in a particular order for purposes of illustration and discussion, the methods of the present disclosure are not limited to the particularly illustrated order or arrangement. The various steps of the method 900 can be omitted, rearranged, combined, and/or adapted in various ways without deviating from the scope of the present disclosure.

At 902, a computing system can obtain input data. The input data may include a query. In some implementations, the query may be a rewritten query. For instance, the query may be a rewritten query generated by obtaining an input query and multi-turn query data and processing the input query and the multi-turn query data with a language model to generate the rewritten query. In some implementations, the multi-turn query data may be descriptive of previous inputs obtained before the input query and the previous inputs. In one implementation, the previous inputs and the input query may be associated with a particular multi-turn session.

At 904, the computing system can process the input data with an embedding model to generate a query embedding. The query embedding may be descriptive of mapping the input data to an embedding space. The query embedding can include a plurality of values associated with features in the input data.

At 906, the computing system can process the input data with a generative model to determine a query intent. The query intent may be descriptive of a type of information being requested. The query intent may be a classification label, a latent encoding, and/or a text output.

At 908, the computing system can obtain, based on the query intent, one or more secondary query embeddings associated with one or more second query intents. The one or more second query intents may be associated with the query intent of the input data. In some implementations, the one or more second query embeddings may be obtained from a query cluster of a data graph associated with a plurality of query clusters. In some implementations, the query intent and the one or more second query intents may be associated with one or more particular topics. The type of information the query intent is descriptive of may then include additional details associated with the one or more particular topics.

At 910, the computing system can evaluate a loss function that evaluates a difference between the query embedding and the one or more second query embeddings. In one implementation, the computing system may evaluate the loss function to evaluate a difference between the query embedding and the one or more second query intents.

At 912, the computing system can adjust one or more parameters of the embedding model based at least in part on the loss function.

In some implementations, the method 900 may include additional steps. For instance, the method 900 may include determining an intent embedding associated with the query intent. The one or more second query embeddings may thus be obtained based on the intent embedding. The method 900 may also include generating a remodeled data graph of query clusters based on the query embedding, the intent embedding, and the one or more second query embeddings. The remodeled data graph of query clusters may include one or more edges associated with tangential topics to the query intent.

Query rewriting and query intent understanding may be implemented in chat interfaces (e.g., large language model enabled chat interfaces) to determine the context of a given input based on the entire chat session and generate a query that reflects the given input and the context of the entire chat session (e.g., details may be added to the query based on previous messages in the chat session). Query rewriting may leverage Large Language Models (LLM) to augment a query based on a determined intent or context of a query that is dependent or relative to other, previously provided, inputs.

In chat sessions (e.g., chat sessions provided via AI chatbot interfaces), user inputs may reference previous responses or inputs making the intent behind a given message difficult to discern from just the text of the message in isolation (e.g., “What is the price of this?” in isolation is vague as the message may reference a discussion topic (e.g., the 2023 new phone from Brand X (e.g., Model Y)) that has been previously mentioned in the chat session). If the intent of a message is unclear and/or vague, search engines and other data processing systems may fail to accurately provide responses and/or may fail to generate relevant content items for the message.

A generative language model can be leveraged to rewrite a query and/or a prompt associated with a chat session to generate a detailed query (and/or prompt) that includes details determined based on previous messages in the chat session. In particular, the language understanding and generation abilities of a generative language model can be utilized to process a given message along with a chat session and generate a new message that includes the given message and additional information from the chat session to encapsulate an intent of the given message. Additionally, a generative model may be leveraged to tune previously generated intent graphs and intent clusters by complementing previous embedding model training/tuning techniques through evaluating the embedding clusters with the intent determination of an LLM. In particular, a generative language model (e.g., an LLM) can process a chat session history to determine additional context for the obtained input query.

Chat sessions can include a plurality of messages that can include a plurality of different information segments that may provide limited information when viewed in isolation. By generating a multi-turn aware query based on a chat session history, a detailed query (and/or prompt) can be generated that includes details from throughout the chat session that can be leveraged to obtain tailored search results and/or a detailed model-generated response. In particular, AI-enabled chat bots have provided an interface where users can have a multi-turn conversation; however, at the end of the session, a user and/or the system may request an action be performed. The query augmentation and the intent mapping to query clusters can be utilized to determine chat-aware search results.

The systems and methods disclosed herein can include using a generative model (e.g., an LLM) to rewrite each “chat-like query” to a more complete query by looking into user sessions (e.g., user chat sessions). Additionally and/or alternatively, the systems and methods can include using an intent graph (e.g., an (LLM-powered) task graph) and a dual-encoder intent mapping model to map the rewritten query into a query intent space.

The systems and methods can include a mechanism to understand a chat-like query in a contextual manner, which may hook up with intent models to facilitate content item retrieval and/or scoring.

For example, a prompt can be designed, determined, generated, and/or constructed to ask a generative language model (e.g., an LLM) to generate a rewritten query, when provided with a full user query history in the same session. In some implementations a generative model can be trained to be a query augmentation model, which can be actively built by one or more efforts. For example, the systems and methods may include a generative language model enabled contextual engine. Additionally and/or alternatively, the systems and methods can leverage a generalized generative model that was pretrained on a plurality of downstream tasks.

An example contextually aware query generation can include: Context: <chat about latest Brand X phone>; User's query: “how expensive is it?”; and Rewritten query: “Brand X Model 17 pro max price”.

The contextually aware query (e.g., the rewritten query) can further be used as input to do Query Intent-DR to map the query to one of the intent spaces in an intent graph (e.g., a task graph). In some implementations, the systems and methods can accurately represent the contextual intent of the user query in an intent representation, which can directly be utilized in various content item retrieval systems. The content item retrieval systems may include an ads retrieval system (e.g., using intent to retrieve relevant Ads/Keywords) and one or more ads auction models (e.g., using intent as feature to represent query, ads, and user state).

In some implementations, the systems and methods can include using a generative model (e.g., an LLM) to further improve current intent models such as an intent graph (e.g., a task graph/query intent representation).

The intent models can be built based on user behavioral signals (e.g., clustering queries that have similar click distribution in a search interface). In some implementations, the one or more intent models can include an “encoder LLM” model to discover relevant queries in parallel to click signals to train and/or tune the intent model.

For example, the systems and methods can include using an LLM to further provide richer attributes on learning an intent space (e.g., task graph nodes and edges), such as commercial attributes of intent and/or next-step intent discovery.

To help both users and content item providers, the system can be configured and/or trained to understand deeper nuances on top of intent representation, by determining and/or providing the (commercial) attributes. For example, after the system maps the user's contextually aware (e.g., rewritten) query “Brand X Model 17 pro max price” to the corresponding intent cluster, the system can further provide attributes on top of the concept around the node of the query embedding cluster (e.g., a commercial intent, a “consumer-facing” (2C) intent, and/or in a “later user funnel” where user might already be considering purchase). Moreover, the systems and methods may even suggest potential next steps of the intent (e.g., user researching intent “Brand X Model 17 pro max price” may also be interested in researching “Brand X warranty”).

For example, an attribute can be useful for content item targeting purposes. With the aid of an LLM, the system can construct a prompt with few-shot examples and can ask the LLM whether a query intent is consumer-facing and/or business-facing.

Another example can include discovering longer-term task intent neighbors. For example, the systems and methods can include designing prompts to ask a generative model (e.g., an LLM) what are the best next steps given the current query intents. The generative model can be configured and/or trained to generate neighbors that are longer-term and/or task oriented, which can be helpful to help users progress.

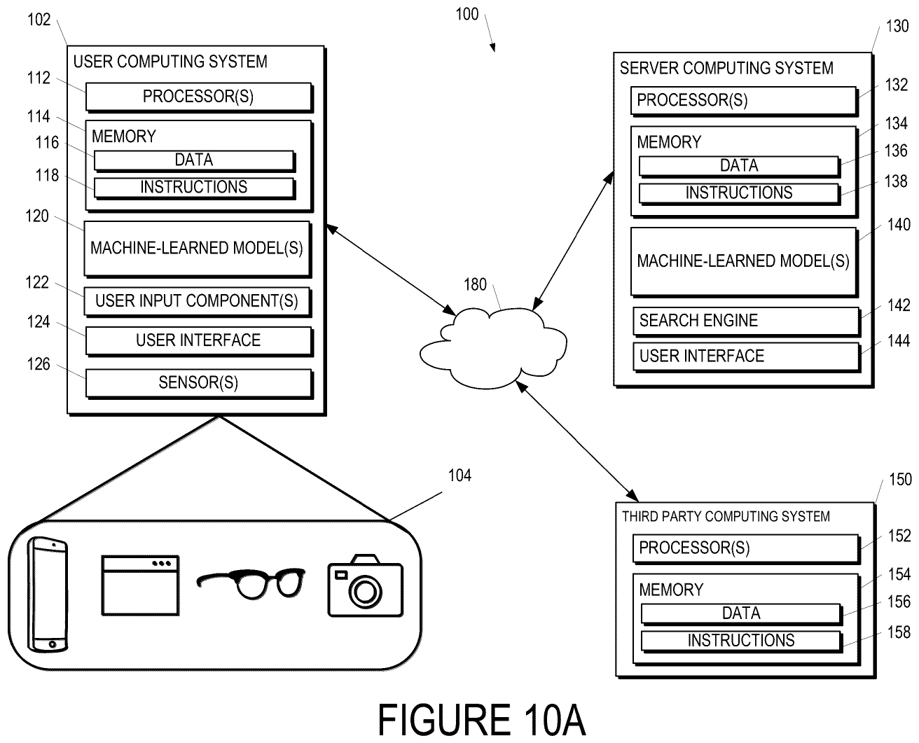

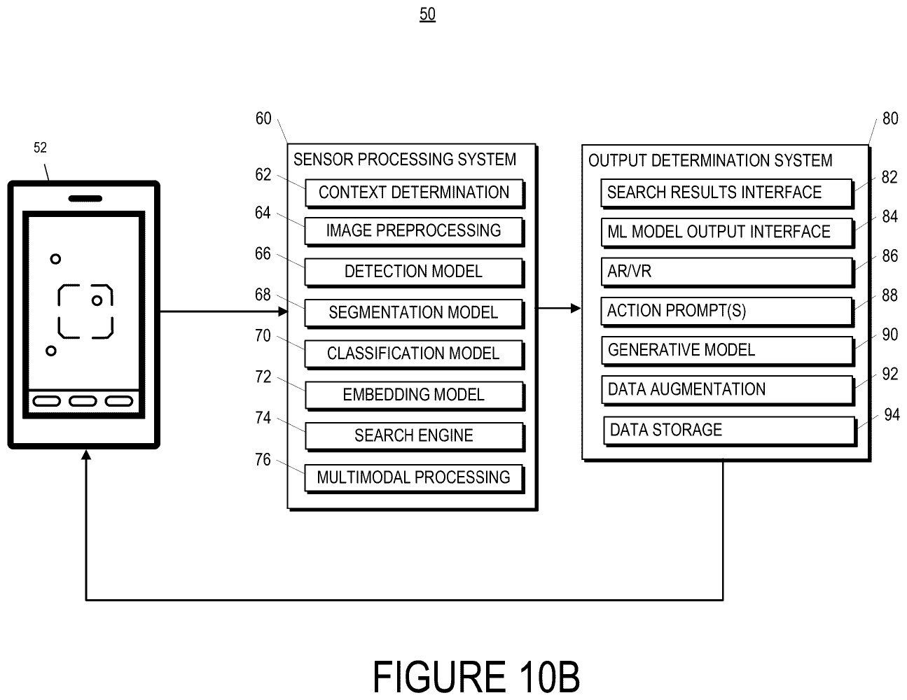

FIG. 10A depicts a block diagram of an example computing system 100 that performs search result generation according to example implementations of the present disclosure. The system 100 includes a user computing system 102, a server computing system 130, and/or a third-party computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or pe part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 9B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 10B depicts a block diagram of an example computing system 50 that performs search result generation according to example implementations of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g. for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for generating a contextually aware query, the method comprising:
obtaining, by a computing system comprising one or more computing devices, an input query;
obtaining, by the computing system, multi-turn query data, wherein the multi-turn query data is descriptive of previous inputs obtained before the input query, wherein the previous inputs and the input query are associated with a particular multi-turn session;
processing, by the computing system, the input query and the multi-turn query data to generate the contextually aware query, wherein the contextually aware query is descriptive of the input query and additional details, wherein the additional details are descriptive of a context of the input query associated with the multi-turn query data;
processing, by the computing system, the contextually aware query with a machine-learned embedding model to generate a query embedding;
determining, by the computing system, a query embedding cluster associated with the query embedding, wherein the query embedding cluster is associated with a plurality of other embeddings associated with a plurality of other queries; and
determining, by the computing system, a plurality of search results based on the query embedding cluster.

2. The computer-implemented method of claim 1, wherein the machine-learned embedding model was trained to generate embeddings that map embeddings associated with similar query intents to a shared embedding cluster.

3. The computer-implemented method of claim 1, the method further comprising:
determining, by the computing system and based on the query embedding cluster, one or more attributes associated with the query embedding, wherein the one or more attributes are descriptive of a particular topic associated with at least one of the input query or with the multi-turn query data.

4. The computer-implemented method of claim 1, wherein the query embedding is associated with a query-intent pair comprising the contextually aware query and a query intent, wherein the query intent is associated with an intent of the input query and the contextually aware query.

5. The computer-implemented method of claim 4, wherein determining a query embedding cluster associated with the query embedding comprises:
mapping, by the computing system, the query-intent pair to an embedding space; and
determining, by the computing system and based on at least one of the query embedding or an intent embedding, the query-intent pair is associated with a plurality of other embeddings associated with a node within a query graph.

6. The computer-implemented method of claim 1, wherein the query embedding cluster is associated with a learned intent graph, wherein the learned intent graph comprises:
a plurality of nodes, wherein each node represents a cluster of queries with related query intents; and
a plurality of edges, wherein the plurality of edges connects nodes with related node intents.

7. The computer-implemented method of claim 1, further comprising:
determining, by the computing system, a plurality of media content items based on the query embedding cluster.

8. The computer-implemented method of claim 1, wherein the input query comprises multimodal data, wherein the multimodal data comprises two or more different types of data.

9. The computer-implemented method of claim 8, wherein the multimodal data comprises image data and text data, and wherein the contextually aware query is generated based on the image data, the text data, and the multi-turn query data.

10. A computing system for generating a multi-turn aware query, the system comprising:
one or more processors; and
one or more non-transitory computer-readable media that collectively store instructions that, when executed by the one or more processors, cause the computing system to perform operations, the operations comprising:
obtaining an input query;
obtaining multi-turn query data, wherein the multi-turn query data is descriptive of previous inputs obtained before the input query, wherein the previous inputs and the input query are associated with a particular multi-turn session;
processing the input query and the multi-turn query data with a machine-learned language model to generate the multi-turn aware query, wherein the multi-turn aware query is descriptive of the input query augmented with additional details determined based on the multi-turn query data;
processing the multi-turn aware query with a machine-learned embedding model to generate a query embedding;
determining a query embedding cluster associated with the query embedding; and
determining a plurality of search results based on the query embedding cluster.

11. The computing system of claim 10, wherein the machine-learned language model comprises a generative language model pre-trained on a diverse variety of content and text to perform a plurality of different language processing tasks.

12. The computing system of claim 10, wherein the query embedding cluster is a cluster of embeddings associated with a plurality of different queries with a similar query intent to the multi-turn aware query, and wherein the query embedding cluster is associated with a node within a task graph, wherein the task graph comprises a plurality of learned nodes associated with a plurality of different query tasks.

13. The computing system of claim 10, wherein the query embedding cluster further comprises a plurality of different queries associated with one or more shared attributes, wherein the one or more shared attributes are associated with one or more query intents.

14. One or more non-transitory computer-readable media that collectively store instructions that, when executed by a computing system, cause the computing system to perform operations, the operations comprising:
obtaining input data, wherein the input data comprises a query;
processing the query with an embedding model to generate a query embedding;
processing the input data with a generative model to determine a query intent, wherein the query intent is descriptive of a type of information being requested;
obtaining, based on the query intent, one or more second query embeddings associated with one or more second queries with one or more second query intents, wherein the one or more second query intents are associated with the query intent of the input data;
evaluating a loss function that evaluates a difference between the query embedding and the one or more second query embeddings; and
adjusting one or more parameters of the embedding model based at least in part on the loss function.

15. The non-transitory computer-readable media of claim 14, wherein the query comprises a rewritten query, wherein the rewritten query was generated by:
obtaining an input query and multi-turn query data, wherein the multi-turn query data is descriptive of previous inputs obtained before the input query, wherein the previous inputs and the input query are associated with a particular multi-turn session; and
processing the input query and the multi-turn query data with a language model to generate the rewritten query.

16. The non-transitory computer-readable media of claim 14, wherein the one or more second query embeddings are obtained from a query cluster of a data graph associated with a plurality of query clusters.

17. The non-transitory computer-readable media of claim 14, wherein the operations further comprise:
determining an intent embedding is associated with the query intent; and
wherein the one or more second query embeddings are obtained based on the intent embedding.

18. The non-transitory computer-readable media of claim 14, wherein the query intent and the one or more second query intents are associated with one or more particular topics, and wherein the type of information comprises additional details associated with the one or more particular topics.

19. The non-transitory computer-readable media of claim 14, wherein the operations further comprise:
generating a remodeled data graph of query clusters based on the query embedding, the intent, and the one or more second query embeddings.

20. The non-transitory computer-readable media of claim 19, wherein the remodeled data graph of query clusters comprises one or more edges associated with tangential topics to the query intent.
